(19) United States
(12) Patent Application Publication
(10) Pub. No.: US 2025/0000273 A1
(43) Pub. Date: Jan. 2, 2025

(54) MATTRESS WITH SEGMENTED FOAM CORE

(71) Applicant: BIA IP Holdco, LLC, Pompano Beach, FL (US)

(72) Inventors: Philip Lane Carlitz, Glencoe, IL (US); Stuart Scott Carlitz, Yardley, PA (US)

(21) Appl. No.: 18/421,473

(22) Filed: Jan. 24, 2024

Related U.S. Application Data
(60) Provisional application No. 63/510,510, filed on Jun. 27, 2023.

(51) Int. Cl. A47C 27/14; A47C 27/00; A47C 27/15; A47C 27/20; B32B 3/04; B32B 3/30; B32B 5/02; B32B 5/18; B32B 5/24; B32B 5/32; B32B 7/09

(52) U.S. Cl. CPC A47C 27/144; A47C 27/15; A47C 27/20; B32B 3/04; B32B 3/30; B32B 5/022; B32B 5/18; B32B 5/245; B32B 5/32; B32B 7/09; A47C 27/002; B32B 2266/0207; B32B 2266/0278; B32B 2266/06; B32B 2307/72; B32B 2307/7376; B32B 2479/00

(57) ABSTRACT

A mattress including a support core formed from a high-density foam, one or more comfort layers, and a mattress cover is disclosed. The support core includes a top face, a bottom face, a first lateral face, and a second lateral face with a cranial flexion channel, a caudal flexion channel, and at least one stress relief channel position on the bottom face. The cranial flexion channel and the caudal flexion channel are each formed from gaps having a width of 0.5 to 2.5 inches and the at least one stress relief channel is formed from a cut in the high-density foam extending between the first lateral face and the second lateral face. The cranial flexion channel, the caudal flexion channel, and the at least one stress relief channel each have a depth leaving a residual thickness of intact high-density foam of 1 inch to 3 inches aligned with each channel.

### CROSS-REFERENCE TO RELATED APPLICATION

This application claims priority to U.S. Provisional Application 63/510,510, filed Jun. 27, 2023, which is incorporated by reference herein in its entirety.

### FIELD

The present invention relates to mattress structures and in particular to a mattress structure with a foam support core having channels and cuts provided across a width of the support core to facilitate flexion of the mattress.

### BACKGROUND

Adjustable beds have been used for many years to permit the user to adjust the head and foot sections of the bed to different positions. The head and foot sections of an adjustable base may be adjusted manually or with the assistance of motors operated by the user via a remote control. Adjustable beds were originally designed principally for use in medical environments by patients who had to spend long periods of time in bed for reasons while at a medical facility. However, more recently, adjustable beds are also being used in residential environments by users who have no health or physical impairment. For example, people may desire for the head section of their bed and mattress to be raised to allow for soft support when viewing television or reading a book. Further, raising the head section or the foot section of a bed when sleeping may provide relief from swollen ankles, acid efflux, or other uncomfortable maladies while sleeping.

Adjusting the head and foot sections of an adjustable base concurrently necessitates flexion and bending of any mattress placed on the adjustable base. However, it will be readily appreciated that bending a mattress may result in stretching or tearing of the mattress structure in regions on the outer face of the bend and compression or brushing of the mattress structure in regions on the inner face of the bend. Further, the mattress may not remain against the adjustable base and form gaps between the mattress and the adjustable base as the mattress is unable to fully stretch or compress to conform to the shape of the adjustable base.

### SUMMARY

The present invention overcomes these and other disadvantages of the prior art by providing an improved mattress structure, in which a support core within the mattress include gaps and cuts to allow for flexion of the mattress without tearing or crushing the internal mattress structure. This innovative structure include removal of sections of the high-density foam forming the support core of the mattress in stripes across the width of the mattress to allow for flexion of the support core without compressive or stretching interference as well as cuts in the high-density foam across the width of the mattress to relieve stress and allow the support core to stretch without tearing. The mattress according to the present disclosure provides an improved structure for utilization with an adjustable base.

According to at least one embodiment, a mattress is disclosed. The mattress comprises a support core formed from a high-density foam, one or more comfort layers positioned adjacent a top face of the support core, and a mattress cover encasing the support core and the one or more comfort layers. The support core comprises a top face, a bottom face, a first lateral face, and a second lateral face with the bottom face comprising a cranial flexion channel positioned proximal a first end of the mattress, a caudal flexion channel positioned proximal a second end of the mattress, and at least one stress relief channel position between the cranial flexion channel and the caudal flexion channel. The cranial flexion channel is formed from a gap having a width of 0.5 to 2.5 inches in the high-density foam extending between the first lateral face and the second lateral face of the support core and to a cranial channel depth such that the high-density foam has a residual thickness of 1 inch to 3 inches aligned with the cranial flexion channel. The caudal flexion channel is formed from a gap having a width of 0.5 to 2.5 inches in the high-density foam extending between the first lateral face and the second lateral face of the support core and to a caudal channel depth such that the high-density foam has a residual thickness of 1 inch to 3 inches aligned with the caudal flexion channel. Finally, the at least one stress relief channel is formed from a cut in the high-density foam extending between the first lateral face and the second lateral face of the support core and to a stress relief channel depth such that the high-density foam has a residual thickness of uncut high-density foam of 1 inch to 3 inches aligned with the at least one stress relief channel.

These and additional objects and advantages provided by the embodiments of the present invention will be more fully understood in view of the following detailed description and the accompanying Figures, wherein like reference numerals refer to like parts.

### BRIEF DESCRIPTION OF THE DRAWING

In the accompanying Figures:

FIG. 1 is a sectional view of a mattress comprising a support core according to one or more embodiments of the present disclosure;

FIG. 2 is a side view of a support core according to one or more embodiments of the present disclosure; and

FIG. 3 is a bottom view of a support core according to one or more embodiments of the present disclosure.

### DETAILED DESCRIPTION

The numerous innovative teachings of the present application will be described with particular reference to certain preferred embodiments. However, it should be understood that these classes of embodiments provide only a few examples of the many advantageous uses of the innovative teachings herein. In general, statements made in the specification of the present application do not necessarily delimit any of the various claimed inventions. Moreover, some statements may apply to some inventive features but not to others.

The mattress 10 comprises a multicomponent structure formed from a plurality of distinct components or layers. Specifically, the mattress 10 comprise a support core 20 formed from a high-density foam, one or more comfort layers 30, and a mattress cover 40. The support core 20 comprises a top face 22, a bottom face 24, a first lateral face 26, and a second lateral face 28 with the bottom face 24 comprising a cranial flexion channel 50 positioned proximal a first end 52 of the mattress 10, a caudal flexion channel 60 positioned proximal a second end 62 of the mattress 10, and at least one stress relief channel 70 position between the cranial flexion channel 50 and the caudal flexion channel 60. Further, the cranial flexion channel 50 is formed from a gap having a width (W₁) of 0.5 to 2.5 inches in the high-density foam, extending between the first lateral face 26 and the second lateral face 28 of the support core 20, and to a cranial channel depth such that the high-density foam has a residual thickness (R₁) of 1 inch to 3 inches aligned with the cranial flexion channel 50. Similarly, the caudal flexion channel 60 is formed from a gap having a width (W₂) of 0.5 to 2.5 inches in the high-density foam, extending between the first lateral face 26 and the second lateral face 28 of the support core 20, and to a caudal channel depth such that the high-density foam has a residual thickness (R₂) of 1 inch to 3 inches aligned with the caudal flexion channel 60. Further, the at least one stress relief channel 70 is formed from a cut in the high-density foam, extending between the first lateral face 26 and the second lateral face 28 of the support core 20, and to a stress relief channel depth such that the high-density foam has a residual thickness (R₃) of uncut high-density foam of 1 inch to 3 inches aligned with the at least one stress relief channel 70. Finally, the one or more comfort layers 30 are positioned adjacent the top face 22 of the support core 20 with the mattress cover 40 encasing the support core 20 and the one or more comfort layer 30.

Having generally described the mattress 10, the various components and layers of the mattress 10 will be disclosed in greater detail.

The mattress 10 includes a support core 20 formed from a high-density foam forming the structure of the mattress 10. A mattress 10 intended to be utilized with an adjustable base must be able to bend and flex to follow the contour of the adjustable base. It will be appreciated that an adjustable base may be able to lift the head and foot sections of a mattress up to between 40 and 70 degrees from level necessitating substantial; flexion and bending of the mattress 10. The high-density foam of the support core 20 provides a structural and supportive layer for the mattress 20 while still allowing for bending and flexion of the mattress 10.

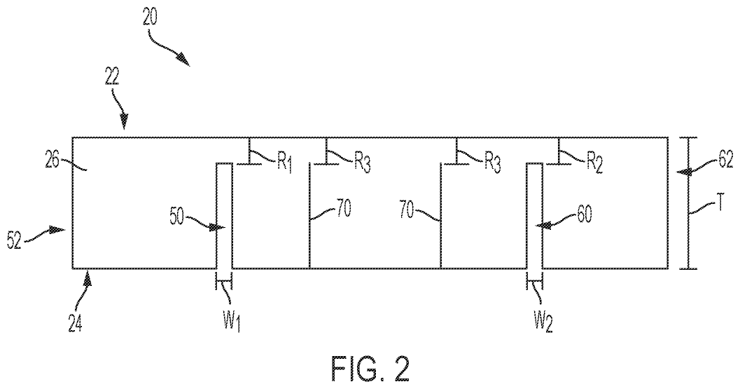

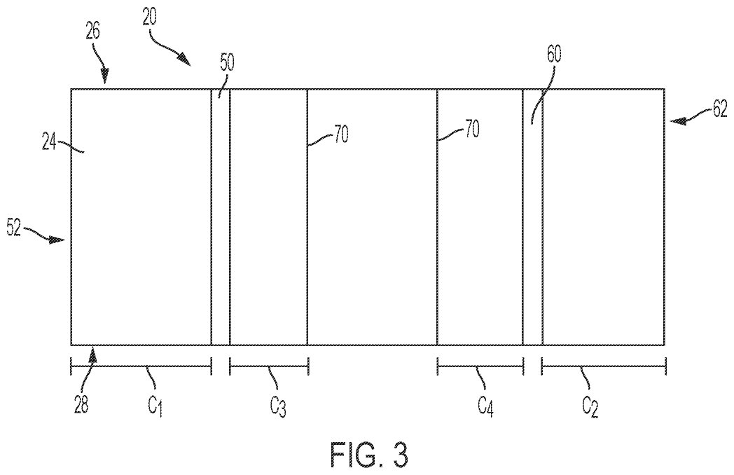

The support core 20 includes a top face 22, a bottom face 24, a first lateral face 26, and a second lateral face 28 as delineated in FIGS. 2 and 3. The top face 22 and the bottom face 24 conform with the surfaces typically associated with the top and bottom of the mattress 10. The first lateral face 26 and the second lateral face 28 conform with the surfaces typically associated with the sides of the mattress 10.

To allow for case of bending and flexion of the mattress, the bottom face 24 of the support core 20 includes removed sections of the high-density foam as well as slits or cuts within the high-density foam forming the support core 20. Specifically, the bottom face 24 includes a cranial flexion channel 50 positioned proximal a first end 52 of the mattress 10, a caudal flexion channel 60 positioned proximal a second end 62 of the mattress 10, and at least one stress relief channel 70 position between the cranial flexion channel 50 and the caudal flexion channel 60. The first end 52 of the mattress 10 to which the cranial flexion channel 50 is proximally provided is the end of the mattress 10 where the sleeper's head is positioned. Conversely, the second end 62 of the mattress 10 to which the caudal flexion channel 60 is proximally provided is the end of the mattress 10 where the sleeper's feet are positioned. It will be appreciated that such naming convention is aligned with the anatomical direction terms of cranial meaning toward the head end of the body and caudal meaning away from the head.

The cranial flexion channel 50 provides improved flexion of the mattress 10 during adjustment of the adjustable base to raise or lower the sleeper's head and/or torso. The cranial flexion channel 50 is formed from a gap in the high-density foam extending between the first lateral face 26 and the second lateral face 28 of the support core 20. Specifically, the cranial flexion channel 50 is formed by removal of the high-density foam across the width of the mattress 10 to form the gap in the bottom face 24 of the support core 20. In various embodiments and with reference to FIG. 2, the gap forming the cranial flexion channel 50 has a width (W₁) of 0.5 to 2.5 inches, 1.0 to 2.5 inches, 1.0 to 2.0 inches, or approximately 1.5 inches. Further, the cranial flexion channel 50 further is formed by removal of the high-density foam to a cranial channel depth such that the high-density foam has a residual thickness (R₁) of 1 inch to 3 inches aligned with the cranial flexion channel 50. In various further embodiments, the residual thickness (R₁) of the high-density foam aligned with the cranial flexion channel 50 is 1 to 2.5 inches, 1 to 2.0 inches, 1.25 to 1.75 inches, or approximately 1.5 inches.

In one or more embodiments and with reference to FIG. 3, the cranial flexion channel 50 may be positioned at a cranial flexion channel distance (C₁) of 12 inches to 24 inches from the first end 52 of the mattress 10. In various further embodiments, the cranial flexion channel 50 may be positioned at a cranial flexion channel distance (C₁) of 14 inches to 22 inches, 14 inches to 20 inches, 16 inches to 24 inches, 16 inches to 20 inches, or approximately 18 inches from the first end 52 of the mattress 10. It will be appreciated that the positioning of the cranial flexion channel 50 may be selected based on with the location of flexion the adjustable base and the size of the mattress 10.

The caudal flexion channel 60 provides improved flexion of the mattress 10 during adjustment of the adjustable base to raise or lower the sleeper's feet and/or legs. The caudal flexion channel 60 is formed from a gap in the high-density foam extending between the first lateral face 26 and the second lateral face 28 of the support core 20. Specifically, the caudal flexion channel 60 is formed by removal of the high-density foam across the width of the mattress 10 to form the gap in the bottom face 24 of the support core 20. In various embodiments and with reference to FIG. 2, the gap forming the caudal flexion channel 60 has a width (W₂) of 0.5 to 2.5 inches, 1.0 to 2.5 inches, 1.0 to 2.0 inches, or approximately 1.5 inches. Further, the caudal flexion channel 60 further is formed by removal of the high-density foam to a cranial channel depth such that the high-density foam has a residual thickness (R₂) of 1 inch to 3 inches aligned with the cranial flexion channel 50. In various further embodiments, the residual thickness (R₂) of the high-density foam aligned with the cranial flexion channel 50 is 1 to 2.5 inches, 1 to 2.0 inches, 1.25 to 1.75 inches, or approximately 1.5 inches.

In one or more embodiments and with reference to FIG. 3, the caudal flexion channel 60 may be positioned at a caudal flexion channel distance (C₂) of 12 inches to 24 inches from the second end 62 of the mattress 10. In various further embodiments, the caudal flexion channel 60 may be positioned at a caudal flexion channel distance (C₂) of 14 inches to 22 inches, 14 inches to 20 inches, 16 inches to 24 inches, 16 inches to 20 inches, or approximately 18 inches from the second end 62 of the mattress 10. It will be appreciated that the positioning of the caudal flexion channel 60 may be selected based on with the location of flexion the adjustable base and the size of the mattress 10.

The at least one stress relief channel 70 provides improved flexion of the mattress 10 in a central region during adjustment of the adjustable base to raise or lower the sleeper's head and/or torso and/or feet and/or legs. The at least one stress relief channel 70 is formed from a cut in the high-density foam extending between the first lateral face 26 and the second lateral face 28 of the support core 20. Specifically, the at least one stress relief channel 70 is formed by slicing the high-density foam across the width of the mattress 10 on the bottom face 24 of the support core 20. In various embodiments and with reference to FIG. 2, the cut forming the at least one stress relief channel 70 extends to a stress relief channel depth such that the high-density foam has a residual thickness (R₃) of 1 inch to 3 inches aligned with the at least one stress relief channel 70. In various further embodiments, the residual thickness (R₃) of the high-density foam aligned with the at least one stress relief channel 70 is 1 to 2.5 inches, 1 to 2.0 inches, 1.25 to 1.75 inches, or approximately 1.5 inches. Further, while the at least one stress relief channel 70 is described as a cut in the high-density foam it will be appreciated that the stress relief channel 70 may form a channel having a width of up to 0.1 inches.

In one or more embodiments and with reference to FIG. 3, one of the at least one stress relief channels 70 may be positioned at a cranial stress relief channel distance (C₃) of 6 inches to 18 inches from the cranial flexion channel 50. In various further embodiments, one of the at least one stress relief channels 70 may be positioned a cranial stress relief channel distance (C₃) of 6 inches to 16 inches, 8 inches to 18 inches, 8 inches to 16 inches, 10 inches to 14 inches, or approximately 12 inches from the cranial flexion channel 50.

In one or more embodiments and with reference to FIG. 3, one of the at least one stress relief channels 70 may be positioned a caudal stress relief channel distance (C₄) of 6 inches to 18 inches from the caudal flexion channel 60. In various further embodiments, one of the at least one stress relief channels 70 may be positioned a caudal stress relief channel distance (C₄) of 6 inches to 16 inches, 8 inches to 18 inches, 8 inches to 16 inches, 10 inches to 14 inches, or approximately 12 inches from the caudal flexion channel 60.

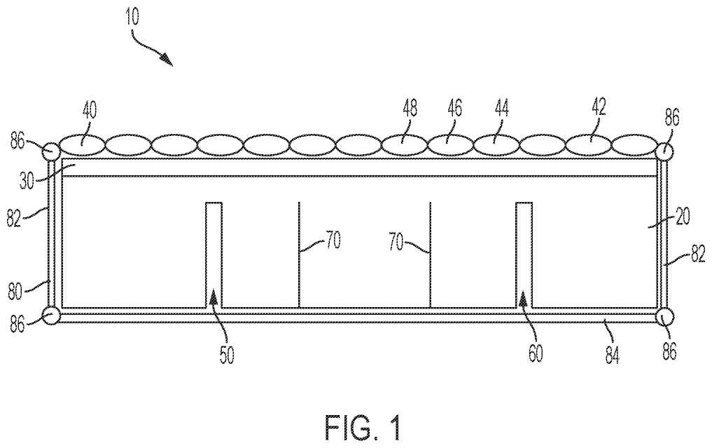

In one or more embodiments and with reference to FIGS. 1-3, the support core 20 may comprise at least two stress relief channels 70. In various embodiments with at least two stress relief channels 70, one of the at least two stress relief channels 70 may be positioned a cranial stress relief channel distance (C₃) of 6 inches to 18 inches, 6 inches to 16 inches, 8 inches to 18 inches, 8 inches to 16 inches, 10 inches to 14 inches, or approximately 12 inches from the cranial flexion channel 50 and one of the at least two stress relief channels 70 may be positioned a caudal stress relief channel distance (C₄) of 6 inches to 18 inches, 6 inches to 16 inches, 8 inches to 18 inches, 8 inches to 16 inches, 10 inches to 14 inches, or approximately 12 inches from the caudal flexion channel 60. It will be appreciated that the positioning of the stress relief channels 70 may be selected based on the location of flexion the adjustable base and the size of the mattress 10.

In one or more embodiments and with reference to FIG. 2, the support core 20 comprises a maximum thickness (T) of 6 inches to 8 inches. Specifically the thickness (T) of the support core 20 in the regions not aligned with the cranial flexion channel 50, the caudal flexion channel 60, or any of the at least one stress relief channels 70 is in the range of 6 inches to 8 inches. As such, it will be appreciated that a support core having a residual thickness (R₁) aligned with the cranial flexion channel 50 of 1.5 inches would result in from a cranial channel depth of 4.5 inches to 6.5 inches. One skilled in the art can determine the cranial channel depth, the caudal channel depth, and/or the stress relief channel depth necessary to achieve the desired residual thickness (R₁, R₂, R₃) based on a known thickness (T) of the support core 20.

In one or more embodiments, the high-density foam forming the support core 20 comprises polyurethane. For purposes of the present disclosure, “high-density” is considered as 1.5 pounds per cubic foot (pcf) or greater.

The mattress 10 includes one or more comfort layers 30 positioned adjacent the top face 22 of the support core 20. The comfort layers 20 determines the overall feel, temperature regulation, and firmness a sleeper feels when using the mattress 10. In various embodiments, the one or more comfort layers 30 positioned between the support core 20 and the quilted panel 42 are formed from a panel of foam, microcoils, a bat of natural fiber, or their combinations. The specific number of layers and the make-up of each layer forming the comfort layers 30 may be determined based on the desired characteristics and parameters desired for the finished mattress 10. Further, while panels of foam, microcoils, bats of natural fiber, or their combinations are provided as specific examples of potential layers forming the one or more comfort layers 30, it will be readily appreciated that additional types of layers commonly utilized in the mattress industry may also be utilized.

In various embodiments, the one or more comfort layers 30 have a total thickness ranging from ¼ inch to 6 inches, ½ inch to 4 inches, or ½ inch to 2 inches. The individual layers of the one or more comfort layers 30, including panels of foam, microcoils, and bats of natural fiber, as present, may be divided between the total thickness of the one or more comfort layers 30. For example, an individual layer of the one or more comfort layers 30 may have a thickness ranging from ¼ inch to 6 inches, ½ inch to 1 inch, or a thickness of approximately ¾ inch. Further, in one or more embodiments, the one or more comfort layers 30 extend substantially across the entire width and length of the mattress 10. However, it is noted that a particular layer of the one or more comfort layers 30 may or may not be homogenous across the entire width and length of the mattress 10 and may have cuts, change in thickness, or change in composition in various regions.

In one or more embodiments, the one or more comfort layers 30 include at least one panel of foam. In various embodiments, the panel of foam may be formed from one or more of a latex foam, a cooling foam. an open-celled foam, and a memory foam.

In one or more embodiments, one or more of the comfort layers 30 may be a latex foam layer. Latex foam is a temperature-neutral and hypoallergenic material which provides support without deep sinkage of the sleeper into the mattress 10.

In one or more embodiments including a cooling foam layer as one or more of the comfort layers 30. the cooling foam layer may be formed from a gel memory foam which includes thermal gel or phase-changing gel. A gel memory foam is naturally cool to the touch. A phase-changing gel transitions from a solid to a liquid when the temperature of the phase-changing gel increases. Inclusion of thermal gel or phase-changing gel adsorbs heat reducing temperature rise of the mattress 10. Both of these gels are designed to draw heat away from the sleeper, resulting in a more comfortable surface temperature for the mattress 10.

In one or more embodiments including a memory foam layer as one or more of the comfort layers 30, the memory foam layer may be a polyurethane foam. Further, in various embodiments, the memory foam may have a density in the approximate range of 1.8 to 4.0 pounds per cubic foot, 2.0 to 4.0 pounds per cubic foot, 2.6 to 3.4 pounds per cubic foot, or approximately 3 pounds per cubic foot. In one or more embodiments, the memory foam layer may have an indentation load deflection ILD rating greater than 60.

In one or more embodiments including an open-cell foam layer as one or more of the comfort layers 30, the open-cell foam layer provides a ventilated foam layer which increases airflow through the layers of the mattress 10. Specifically, the open-cell structure may provided increased airflow and responds more rapidly to compression than traditional memory foams. Further, the open-cell foam layer provides a breathable material which optimizes air flow and boosts temperature regulation. The open-cell foam may be formed from the same materials as a traditional memory foam layer but include open-cells or air pockets that allow for ventilation and air flow throughout the mattress 10, which helps disperse heat.

In one or more embodiments, the one or more comfort layers 30 include at least one bat of natural fiber. Example natural fibers includes wool, cotton, cashmere, silk, horsehair, hemp, and alpaca fleece. Inclusion of one or more bats of natural fibers as one or more of the comfort layers 30 can add either a plush or firm feel to the mattress 10. For example, softer fibers such as cotton and wool may provide a more plush mattress 10, while horsehair will add a firmer feel to the mattress 10.

In one or more embodiments, the one or more comfort layers 30 include at least layer formed from micro-coils. Inclusion of micro-coils as one of the comfort layers 30 adds support and responsiveness to the sleeping surface of the mattress 10. The added support and responsiveness is desirable, especially in the lumbar region as such region supports a bulk of the body weight, thus providing more support for the heaviest parts of the sleeper's body and relieving pressure on the lower back. Inclusion of the layer of micro-coils enhances the sleep surface by including a coiled sleep surface which improves air circulation within the mattress 10 to deliver improved comfort for the sleeper. Micro-coils may be formed from a plurality of small spring coils arranged in a grid and encased in a non-woven fabric. The non-woven fabric forms an encasement of each spring coil individually. The individual spring coils encased in the non-woven fabric form a cohesive sheet of regularly spaced spring coils. The individual spring coils forming the layer of micro-coils may have a height and diameter each in the range of 0.5 to 2 inches. For example, in one or more embodiments, the individual spring coils forming the layer of micro-coils may have a height of 1.5 inches and a diameter of 1.5 inches. Sheets of micro-coils are commercially available as NANOCOIL from Legget & Platt (Carthage, MO). Further, in one or more embodiments, the spring coils may be formed from steel wire having a thickness of 14 gauge (2.1 millimeters) to 21 gauge (0.72 millimeters) to provide the desired stiffness.

With reference to FIG. 1, in one or more embodiments, the mattress cover 40 includes a quilted panel 42 providing a plush sleeping surface and a fabric surround 80 to fully encase the support core 20 and the one or more comfort layers 30. The quilted panel 42 is aligned with the top face 22 of the support core 20 and fabric surround 80 provides the exterior surface for the remaining faces of the mattress 10. Specifically, the fabric surround 80 may be formed from end panels 82 providing the exterior surface of the first end 52 and the second end 62 of the mattress 10, a bottom panel 84 covering the bottom face 24 of the support core 20, and side panels (not shown) providing the exterior surface of the mattress 10 aligned with the first lateral face 26 and the second lateral face 28 of support core 20. In various embodiments, the fabric surround 80 may be formed from a knitted fabric or a woven fabric such as damask or ticking. In one or more embodiments, the quilted panel 42 and the fabric surround 80 are sown together to form an enclosed casing using binding tape or piping 86.

With reference to FIG. 1, in one or more embodiments the mattress cover 40 comprises a quilted panel 42 having a ticking material 44, a backing material 46, and a support material 48 having a degree of compression provided between the ticking 44 and backing materials 46. The ticking material 44, the support material 48 and the backing material 46 all are quilted together into a cohesive unit to form the quilted panel. Specifically, the quilted panel 42 is formed from a sheet of upholstery ticking 44 stitched to a backing layer 46 along with a support material 48, such as a relatively thin and less dense foam or fill layer provided therebetween. To stitch the quilted panel 42, the ticking 44, the backing 46, and the support material 48 are fed into a conventional quilting machine, such as for example, a GI-4300-WCS class III computer driven double lock chain stitch quilter, made by Gribetz International, Inc., Sunrise, Fla. In one embodiment, the stitching is a top thread, such as for example, a 3-ply, 150 denier polyester, 475 total denier, and a bottom thread, such as a 2-ply, 150 denier polyester, 340 total denier, stitched with a needle having a #24 gauge with a stitch size of 6-9 per inch. In other embodiments, other thread types, gauges, and stitch sizes may be used. In one embodiment, the ticking 44 may be 100-150 end Damask, and the backing layer 46 a non-woven fabric, e.g. Accord™ or Vantex™ of 0.5 to 1.5 ounce weight, and combinations thereof. In one embodiment, support material 48 is a polymer foam or fill layer, and in other embodiments may be any foam or fill layer that compresses when stitched to provide the quilted panel 42. Once the quilting has been done, the resulting quilted material is fed into a panel cutting machine, such as the OCS-90, by Gribetz, where panels of appropriate lengths (widths of finished products) are cut.

In one or more embodiments, the stitching density of the quilted panel 42 may be non-homogenous across the entirety of the quilted panel 42. For example, the stitching pattern may provide a center section of the quilted panel 42 that has more stitching then adjacent sections more proximal the first end 52 and the second end 62 of the mattress 10. In one embodiment, the center section may represent approximately ⅓ of the mattress 10. In other embodiment, the center section may range in size from about ¼ to about ½ of the mattress. In other words, the center section can range in size from about ¼ to about ½ of the total area of the quilted panel 42 in top view. In accordance with various embodiments, the stitching may be provided in a star pattern (e.g., 2.85″×2.85″) with a six inch jump between patterns, a circle pattern (e.g., 1.6″×1.6″), a swoop pattern (e.g., 3″×2″), with other jumps ranging from 3 to 9 inches depending on desired comfort. In still other embodiments, the stiching may be a ribbon pattern (e.g., 6″×3″), a 213 pattern (e.g., 6″×3″), or a 301 pattern (e.g., 12″×6″, or 6″×3″). It is to be appreciated that a smaller jump spacing will tend to provide firmer support with more compression of the support material 48 provided in the quilted panel 42, and wider spacing will provide a softer, more plush surface. The overall dimensions of the mattress 10 may be any standard mattress size, e.g., Twin, Full, Queen, King, and California King.

In one or more embodiments, the materials and fabrics forming the quilted panel 42, the fabric surround 80, or the entire mattress cover 40 may be treated with a flame retardant and/or anti-microbial treatment. Further, in one or more embodiments, the mattress cover 40 may be removable from the support core 20, the one or more comfort layers 30, and any additional layers forming the mattress 10 to allow for laundering or other cleaning of the mattress cover 40.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modification and variations come within the scope of the appended claims and their equivalents.

As used throughout, the singular forms “a,” “an” and “the” include plural referents unless the context clearly dictates otherwise. Thus, for example, reference to “a” component includes aspects having two or more such components, unless the context clearly indicates otherwise.

It should be understood that any two quantitative values assigned to a property or measurement may constitute a range of that property or measurement, and all combinations of ranges formed from all stated quantitative values of a given property or measurement are contemplated in this disclosure.

As used here and in the appended claims, the words “comprise,” “has,” and “include” and all grammatical variations thereof are each intended to have an open, non-limiting meaning that does not exclude additional elements or steps.

Having described the subject matter of the present disclosure in detail and by reference to specific embodiments thereof, it is noted that the various details disclosed within should not be taken to imply that these details relate to elements that are essential components of the various embodiments described within, even in cases where a particular element is illustrated in each of the drawings that accompany the present description. Further, it should be apparent that modifications and variations are possible without departing from the scope of the present disclosure, including, but not limited to, embodiments defined in the appended claims. More specifically, although some aspects of the present disclosure are identified as particularly advantageous, it is contemplated that the present disclosure is not necessarily limited to these aspects.

What is claimed is:

1. A mattress comprising:
a support core formed from a high-density foam, wherein:
the support core comprises a top face, a bottom face, a first lateral face, and a second lateral face,
the bottom face comprises a cranial flexion channel positioned proximal a first end of the mattress, a caudal flexion channel positioned proximal a second end of the mattress, and at least one stress relief channel position between the cranial flexion channel and the caudal flexion channel,
the cranial flexion channel being formed from a gap having a width of 0.5 to 2.5 inches in the high-density foam extending between the first lateral face and the second lateral face of the support core and to a cranial channel depth such that the high-density foam has a residual thickness of 1 inch to 3 inches aligned with the cranial flexion channel,
the caudal flexion channel being formed from a gap having a width of 0.5 to 2.5 inches in the high-density foam extending between the first lateral face and the second lateral face of the support core and to a caudal channel depth such that the high-density foam has a residual thickness of 1 inch to 3 inches aligned with the caudal flexion channel,
the at least one stress relief channel being formed from a cut in the high-density foam extending between the first lateral face and the second lateral face of the support core and to a stress relief channel depth such that the high-density foam has a residual thickness of uncut high-density foam of 1 inch to 3 inches aligned with the at least one stress relief channel;
one or more comfort layers positioned adjacent the top face of the support core; and
a mattress cover encasing the support core and the one or more comfort layers.

2. The mattress of claim 1, wherein the support core comprises a maximum thickness of 6 inches to 8 inches.

3. The mattress of claim 1, wherein the width of the gaps forming the cranial flexion channel and the caudal flexion channel are in the range of 1.0 to 2.0 inches.

4. The mattress of claim 1, wherein the cranial flexion channel is positioned 12 inches to 24 inches from the first end of the mattress.

5. The mattress of claim 1, wherein the caudal flexion channel is positioned 12 inches to 24 inches from the second end of the mattress.

6. The mattress of claim 1, wherein one of the at least one stress relief channels is positioned 6 inches to 18 inches from the cranial flexion channel.

7. The mattress of claim 1, wherein one of the at least one stress relief channels is positioned 6 inches to 18 inches from the caudal flexion channel.

8. The mattress of claim 1, wherein the support core comprises at least two stress relief channels.

9. The mattress of claim 8, wherein one of the at least two stress relief channels is positioned 6 inches to 18 inches from the cranial flexion channel and one of the at least two stress relief channels is positioned 6 inches to 18 inches from the caudal flexion channel.

10. The mattress of claim 1, wherein the high-density foam comprises polyurethane.

11. The mattress of claim 1, wherein the mattress cover comprises a quilted panel having a ticking material, a backing material, and a support material having a degree of compression provided between the ticking and backing materials, the ticking material, the support material and the backing material all being quilted together.

12. The mattress of claim 11, wherein the ticking material comprises an upholstery ticking.

13. The mattress of claim 11, wherein the backing material comprises a non-woven fabric.

14. The mattress of claim 11, wherein the support material comprises a polymer foam or fill layer.

15. The mattress of claim 1, wherein the one or more comfort layers comprise a panel of foam, microcoils, a bat of natural fiber, or their combinations.

16. The mattress of claim 15, wherein one or more of the one or more comfort layers comprises a panel of foam, the panel of foam formed from one or more of a latex foam, a cooling foam, an open-celled foam, and a memory foam.

17. The mattress of claim 16, wherein the mattress includes a memory foam layer.

18. The mattress of claim 17, wherein the memory foam layer is a polyurethane foam with a bulk density ranging from about 2.6 to about 4.0 pounds per cubic foot.

19. The mattress of claim 16, wherein the mattress includes a cooling foam layer.

20. The mattress of claim 16, wherein the mattress includes an open-celled foam layer.
